(19) United States
(12) Patent Application Publication
(10) Pub. No.: US 2002/0113375 A1
(43) Pub. Date: Aug. 22, 2002

(54) Pressure differential sealing device

(76) Inventor: Gennady Ruderman, Marblehead, MA (US)

Correspondence Address: Gary L. Loser, Esq., Vice President and General Cousel, Varian Semiconductor Equipment Associates, Inc., 35 Dory Road, Gloucester, MA, 01930, US

(21) Appl. No.: 10/079,027

(22) Filed: Feb. 19, 2002

Related U.S. Application Data
(60) Provisional application No. 60/269,998, filed on Feb. 20, 2001.

(51) Int. Cl. F16J 15/34

(52) U.S. Cl. 277/389

(57) ABSTRACT

A sealing device for maintaining a vacuum seal about a mechanism that passes through a port of a process chamber. At least a portion of the sealing device is sealingly engaged with the mechanism, such as a shaft, and the sealing device may allow the mechanism to be offset relative to the port in at least one degree of freedom. The mechanism may also be moved slidingly and/or rotationally relative to the portion of the sealing device engaged with the mechanism. The sealing device may include a flexible member that allows independent movement of the mechanism while sealing engagement with the mechanism is maintained.

### RELATED APPLICATIONS

This application claims the benefit under 35 USC §119 of the filing date of U.S. provisional application No. 60/269,998, filed Feb. 20, 2001, which is hereby incorporated by reference in its entirety.

### BACKGROUND OF THE INVENTION

1. Field of the Invention

This invention relates to a seal for use with rotating and/or reciprocating shafts.

2. Brief Description of the Prior Art

Over the years, various apparatus have been developed for determining selected characteristics of electron and ion beams, such as the beam configuration, diameter, energy peak, current density, spot size and edge width, etc. These prior approaches are exemplified by U.S. Pat. Nos. 4,336,597; 4,480,220; 4,629,975; and 4,675,528.

The beam characteristics can be measured and controlled by a variety of methods. Some methods use beam detecting devices such as rotating wire devices, pinhole devices, and/or measuring cups such as Faraday cups. The devices and methods mentioned above, as well as others, typically employ some sort of mechanism, such as a motor driven shaft, to rotate, reciprocate or otherwise move the various beam measuring devices and/or other objects within a vacuum chamber. Typically such mechanisms are driven from outside the vacuum chamber. For example, ion beam applications, such as described in U.S. Pat. No. 5,486,080, may involve the use of actuatable arms or robots that are moved within a vacuum chamber. Such movable devices may be shaft driven by a motor or other drive means positioned external to the vacuum chamber. As such, there is a need to provide a seal about the device's drive mechanism to ensure that the vacuum state within the vacuum chamber may be suitably controlled.

While many seals exist which may be suitable for use about a rotating or reciprocating shaft, most seals require that the shaft that passes from the drive motor into the ion beam chamber be precisely positioned in order for an effective seal to be established between the shaft and shaft passageway through the wall into the vacuum chamber. If vibrations of the motor or other external factors shift the position of the shaft within the passageway, the vacuum seal is may be compromised. In addition, many seals have relatively short life spans, and many other sealing methods are simply unsuited to the demanding conditions of a high vacuum environment. For example, in U.S. Pat. No. 4,605,233 it is reported that when some magnetic fluid devices are used to seal a shaft in high vacuum, such fluids may be insufficient to maintain the vacuum seal and thus allow air to contaminate the vacuum environment.

### BRIEF SUMMARY OF THE INVENTION

In accordance with at least one aspect of the invention, seal failure may be reduced or eliminated by providing a compliant mounting of a seal, e.g., so that the seal may move with a shaft and maintain sealing engagement where vibration, misalignment or other conditions cause the shaft to move in unintended directions relative to an opening that is covered by the seal. This is in contrast to some seal arrangements that essentially require the shaft and another reference object, such as a vacuum chamber wall, to remain nearly stationary relative to each other, except for allowed rotary motion of the shaft. Flexible or compliant mounting of the seal can also allow relatively large ranges of motion for the shaft, e.g., where the shaft is intended to be moved in two or more degrees of freedom to manipulate an object in a vacuum chamber. Thus, the shaft may be moved relatively freely while the seal substantially resists air flow into the vacuum chamber at the shaft entrance into the chamber.

At least one aspect of the invention is directed to a shaft seal apparatus for use in vacuum applications. In one aspect, a seal device maintains a vacuum seal about a shaft that is passed through a port of a process chamber. The seal device may include a shaft seal and a flexible mounting collar. An inside surface of the shaft seal may sealingly engage the shaft and may allow the shaft to move rotationally and/or slidingly relative to the seal. The flexible mounting collar may have a first end opening and a second end opening. The first end opening may be sealingly engaged to at least a portion of the shaft seal. The second end opening may be sealingly engaged to a surface about the port of the process chamber. The flexible nature of the mounting may provide the shaft and shaft seal with a predetermined range of motion relative to the port. Thus, the shaft may be offset from a central axis of the port, e.g., moved so that an axis of the shaft is laterally and/or angularly offset from the central axis of the port.

At least one embodiment of the invention provides a vacuum chamber with an externally controlled device that may be reciprocated, rotated or otherwise moved into, out of, or within the vacuum chamber without compromising a pressure differential between the vacuum chamber and ambient air pressure conditions outside the chamber. As such, the present invention may be utilized with a variety of applications such as those involving the movement of Faraday cups or other measuring devices that may be employed in the vacuum chamber of an ion beam measuring apparatus and/or an ion implantation system. An example of an ion beam apparatus is described in U.S. Pat. No. 6,075,249.

In one aspect of the invention, a sealing device provides a seal about a shaft that extends between first and second zones where an air pressure differential exists between the first and second zones. In the first zone, the shaft extends through a port of a process chamber. The sealing device includes a shaft seal having a sealing portion and a support portion, and a seal mount. The sealing portion is constructed and arranged to sealingly engage with a shaft and allow the shaft to be slidingly and/or rotationally moved relative to the sealing portion. The seal mount has a first end, a second end and a flexible member between the first and second ends that enables movement of the first end relative to the second end in at least one degree of freedom. The first end is sealingly engageable to the support portion of the shaft seal, and the second end is sealingly engageable to an engagement surface about a port into a process chamber.

In another illustrative embodiment, a floating shaft seal provides a vacuum seal about a reciprocating and/or rotating shaft. The shaft may pass from a zone at ambient air pressure through an opening in a chamber that has a substantially lower air pressure than ambient. The floating shaft seal includes a sealing member constructed and arranged to sealingly engage with a shaft and allow the shaft to move relative to at least a portion of the sealing member, and a flexible mounting collar. The flexible mounting collar has a first end opening that is sealingly engageable to at least a portion of the sealing member, and a second end opening sealingly engageable about the opening in the chamber.

In another illustrative embodiment, a device maintains a seal about a mobile shaft that extends from a first chamber into a second chamber. The first chamber may have a first pressure, and the second chamber may have a second pressure. The sealing device includes an inner housing having an inside surface and an outside surface. The inside surface defines a substantially cylindrical passage, and a first portion of the substantially cylindrical passage has a first diameter sized to allow passage of the shaft therethrough. An upper mechanical seal member, a lower mechanical seal member, and a spacer seal member are positioned within the substantially cylindrical passage. Each of the seal members has a first surface supported by the first portion of the substantially cylindrical passage, and a second surface sealingly engaged with the shaft. An outer housing comprising a flexible material and having a first end and a second end flexibly supports the inner housing. The first end is sealingly engaged to a portion of the outside surface of the inner housing, and the second end is sealingly engaged to a wall of the second chamber, whereby the inner housing is moveable relative to the wall of the second chamber.

In another illustrative embodiment, an ion beam measuring device includes a vacuum chamber having an inside and an outside defined by a plurality of walls. A measuring device is operatively engaged to a first end of an extendable shaft that passes through an opening in a wall of the vacuum chamber. A second end of the shaft is engaged with a control unit outside the vacuum chamber. The measuring device may be constructed and arranged to measure at least one characteristic of an ion beam in the vacuum chamber. A seal device is mounted adjacent to the opening in the vacuum chamber and sealingly engages with the shaft so that the shaft may move relative to the portion of the shaft seal apparatus that sealingly engages with the shaft.

### BRIEF DESCRIPTION OF THE DRAWINGS

Illustrative embodiments of the invention are described below with reference to the following drawings in which like numerals reference like elements and wherein:

FIG. 1 is a schematic diagram of an illustrative process chamber with a sealing device in accordance with the invention;

FIG. 2 is a cross-sectional side view of a first embodiment of the invention;

FIG. 3 shows the FIG. 2 embodiment in a position where the shaft is offset relative to a central axis of the port;

FIG. 4 is a cross-sectional top view along the line A-A shown in FIG. 2;

FIG. 5 is a cross-sectional side view of a second embodiment of the invention; and

FIG. 6 is a cross-sectional side view of a third embodiment of the invention.

### DETAILED DESCRIPTION

Although illustrative embodiments of the invention are described below in connection with an ion implantation apparatus, the invention is not limited to any particular application. Therefore, embodiments of the invention may be used in any suitable environment or application, particularly those in which a pressure differential exists between two zones.

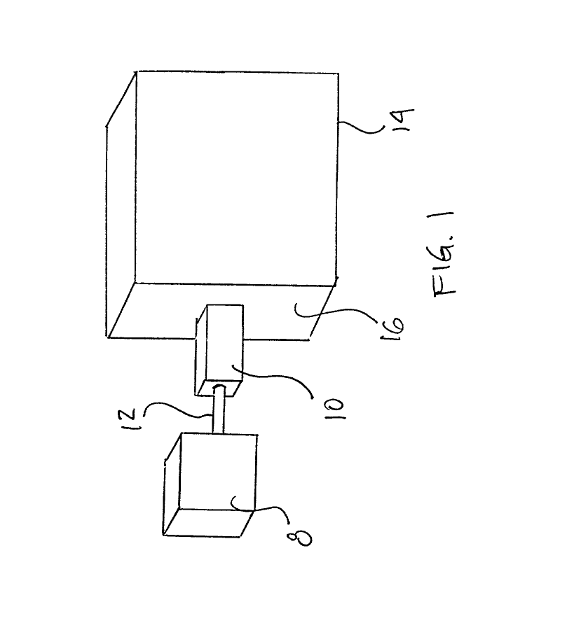

FIG. 1 is a schematic block diagram of a seal device 10 incorporated into an ion implantation system. In this illustrative embodiment, the ion implantation system includes a process chamber 14 within which any suitable process may be performed under relative vacuum conditions or other conditions in which a pressure differential exists between the interior of the process chamber 14 and an environment outside the process chamber 14. For example, semiconductor wafers may be exposed to an ion beam in a relatively low pressure environment inside the process chamber 14, e.g., a pressure of 10⁻³ to about 10⁻¹¹ Torr, while ambient or other relatively higher air pressure conditions are present outside the process chamber 14, as is well known. A control unit 8 may move one or more shafts 12, or other suitable device(s), that pass through a port (not shown) in a wall 16 of the process chamber 14. As discussed above, the control unit 8, which may include a motor drive, robotic device, etc., can use the shaft 12 or other device to move an object inside the process chamber 14. In one illustrative embodiment, the object moved in the chamber 14 may be a Faraday cup or other ion beam detector, but it should be understood that any suitable object, such as a door, wafer holder, etc., may be moved by the control unit 8. Below, embodiments are described with reference to a single shaft operated in a chamber 14, but it should be understood that the term shaft may refer to multiple concentric shafts (e.g., one shaft operating inside another shaft), or any other suitable mechanism. Details regarding the operation of the control unit 8, the Faraday cup or other detector, or other features of an ion implantation system are not provided herein as such details are well understood by those of skill in the art.

In the illustrative embodiment shown in FIG. 1, a seal device 10 may cooperate with the shaft 12 and process chamber 14 to help seal a first zone, e.g., an area of low pressure in the chamber 14, from a second zone, e.g., an area of higher, or ambient, pressure outside the chamber 14. The seal device 10 may be constructed and arranged to allow the shaft 12 to be moved relative to the process chamber 14 and/or at least a portion of the seal device 10. For example, the shaft 12 may be moved by the control unit 8 so that it rotates about a longitudinal axis, slides along its longitudinal axis, and/or rotates about an axis transverse to the shaft's longitudinal axis, etc. Such movement may be provided while helping to prevent movement of air or other fluids from one side of the seal device 10 to the other, e.g., help prevent air flow into the process chamber 14 in an area covered by the seal device 10.

In one illustrative embodiment, the seal device 10 may include a shaft seal having a portion that sealingly engages with the shaft, e.g., cooperates with at least a portion of the shaft to resist air or other fluid flow in an area between the shaft seal and the shaft. The shaft seal may sealingly engage with the shaft in any suitable way, such as in a floating-type, magnetic-type (e.g., using a ferro-magnetic fluid), labyrinth-type, or any other suitable type of sealing arrangement. For example, the shaft seal may be of a floating type seal such as described in U.S. Pat. No. 4,572,518 and U.S. Pat. No. 4,641,842; a labyrinth type seal, such as described in U.S. Pat. No. 5,046,718; a magnetic type seal, such as described in U.S. Pat. Nos. 4,357,024 and 5,137,286, or any other suitable type of seal. The shaft seal may be attached to a first end of a seal mount that is attached at a second end to an engagement surface about a port into the process chamber. The seal mount may include a flexible member between the first and second ends, i.e., between the shaft seal and the engagement surface, so that the shaft seal may be moved in at least one degree of freedom relative to the engagement surface. For example, the shaft seal may be pivoted, rotated, or otherwise moved relative to the engagement surface. Such movement of the shaft seal may allow relatively free movement of the shaft 12 without substantially compromising the seal between the shaft seal and the shaft. In addition, the shaft seal may sealingly engage with the shaft so that the shaft can move relative to the shaft seal. For example, the shaft 12 may rotate and/or slide along its axis relative to the shaft seal while sealing engagement is substantially maintained between the shaft seal and the shaft.

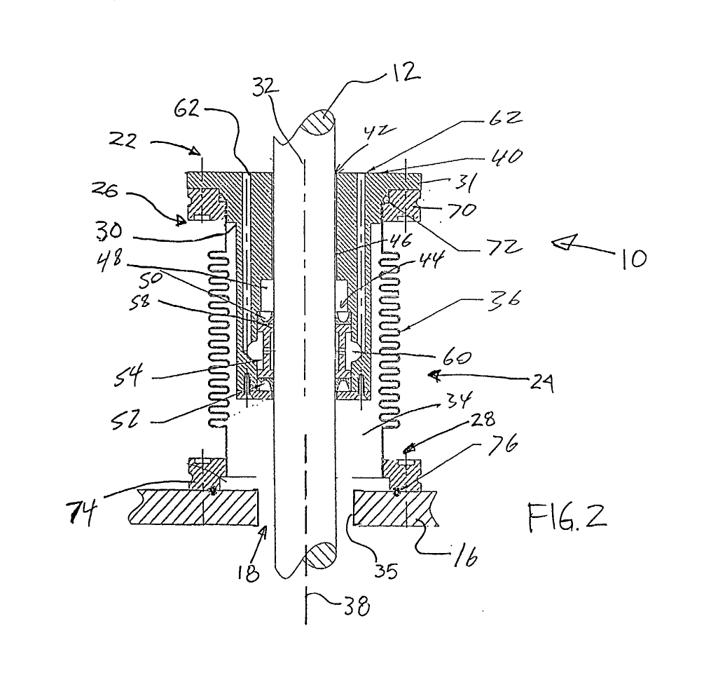

FIG. 2 shows a cross-sectional view of one illustrative embodiment in accordance with the invention. In this embodiment, the seal device 10 may be mounted adjacent a wall 16 of the chamber 14. The shaft 12 may pass through the seal device 10 and through an opening or port 18 into the chamber 14. The size of the port 18 may be larger than the portion of the shaft 12 that passes through the port 18. There is no upper limit to the size of the port 18 save that the port 18 in this embodiment is enclosed by the seal device 10.

The seal device 10 may be characterized as having two primary components: a shaft seal 22 and a seal mount 24. In the embodiment shown, the shaft seal 22 includes a seal housing 40 with a shaft bore 42. The seal housing 40 may be a relatively rigid structure and constructed from materials such as metal, powdered metal, ceramics, metallo-ceramics, rigid plastics and other hardened materials. One or more sealing portions 44 may be positioned within the shaft bore 42 and sealingly engage the shaft 12. The sealing portion 44 may sealingly engage the shaft 12 in any suitable way as discussed above, and may include floating seal rings, sealing fluids such as ferromagnetic fluids or other arrangements to assist in sealing a gap 46 between the shaft 12 and the bore 42. In this embodiment, the sealing portion 44 is positioned within an enlarged portion 48 of the bore 42 and includes an upper seal member 50, a lower seal member 52 and a spacer seal 54 between the upper and lower seal members 50 and 52. The seal members 50 and 52 may be ring-type seals made of flexible and elastomeric material such that they may be temporarily distorted by the reciprocating movement of the shaft 14 to thereby ensure continuous engagement with the shaft 14. Of course, other suitable arrangements may be used for the seal members 50 and 52. The spacer seal 54 maybe a floating seal which has one or more members in contact with the bore 42 and opposing members 58 in flexible sliding contact with the shaft 12.

The sealing portion 44 is not limited to the specific embodiment shown in FIG. 2, and instead may include any suitable number of mechanical seal members or other devices. In addition, in the illustrated embodiment, the sealing portion 44 sealingly engages with a cylindrically-shaped portion of the shaft 12, e.g., so that the shaft 12 may slide longitudinally relative to the sealing portion 44. However, the sealing portion 44 may engage with surfaces of other shapes, such as an annular ring on the shaft 12, a frusto-conical shaped surface, a washer-shaped surface, etc. Further, the term “sealingly engage” does not require that the sealing portion 44 actually contact a surface of the shaft, but rather that the sealing portion 44 form a seal with the shaft that resists fluid flow in a space between the sealing portion 44 and the shaft 12.

The seal mount 24 may include a flexible member 36 or other device between the shaft seal 22 and the chamber wall 16 or other engagement surface so that the shaft seal 22 may be moved independently of the wall 16. In this embodiment, the flexible member 36 may be a substantially collar-shaped ring of material with a first end 26 attached to the shaft seal 22 and a second end 28 attached to the wall 16. For example, the flexible member 36 may be made from a variety of materials, e.g., may include a bellows made of a metal or other suitable material. Alternately, the flexible member 36 may include rigid, jointed elements or other arrangements that allow the shaft seal 22 to be moved relative to the wall 16. Thus, although in the FIG. 2 embodiment the seal mount 24, particularly the flexible member 36, is deformable to allow the shaft seal 22 to move while maintaining sealing engagement with the shaft 12, any other suitable arrangement of the seal device 10 may be used to allow such movement. In some applications, the flexible member 36 may function as the walls of a transition space 34, and as such may have sufficient strength to prevent the flexible member 36 from being ruptured or otherwise damaged by vacuum conditions within the transition space 34. Suitable materials which may be used in constructing the flexible member 36 include natural rubber, silicon rubber and polymeric materials which provide flexibility and strength. Some examples of suitable polymer materials include, but are not limited to: Nylon, Noryl, Teflon, Peek, etc. In the illustrated embodiment, undulations in the flexible member 36 provide the seal mount 24 with a variety of bending points that allow the seal mount 24 to be made from a stronger and/or more structurally rigid material that might otherwise be too inflexible for use. Examples of materials which may benefit from the configuration shown include, but are not limited to: stainless steel, other metals, injection molded ceramics, plastics (see above list), fiberglass, metal matrix composites, other composites.

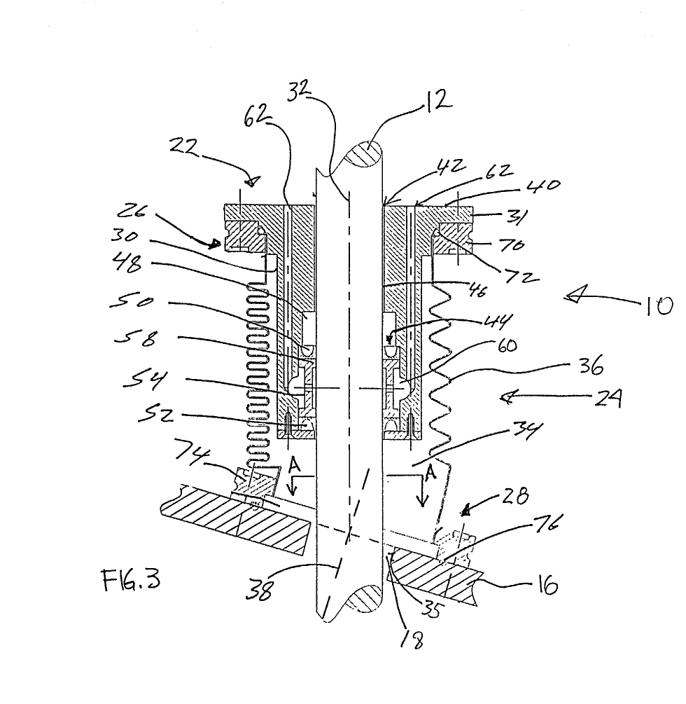

By allowing the shaft seal 22 to be moved independently in at least one degree of freedom relative to the chamber wall 16 or other engagement surface, the seal device 10 may allow the shaft 12 to be offset relative to the port 18. For example, the shaft 12 may be angularly offset, i.e., rotated about an axis transverse to the shaft's longitudinal axis 32, so that the longitudinal axis 32 may be positioned at a range of angles to the port 18. In FIG. 2, the shaft 12 is shown in a position where the longitudinal axis 32 is colinear with a central axis 38 of the port 18, which may be a home position of the shaft 12 while not being driven by the control unit 8. However, in FIG. 3, the shaft 12 is shown in a position where the longitudinal axis 32 is at an angle to the central axis 38. Thus, the shaft 12 may be moved so that the shaft 12 passes through the port 18 at various angles relative to the axis 38 while sealing engagement with the seal device 10 is maintained. In this embodiment, the central axis 38 is an axis perpendicular to the wall 16 that passes through a centerpoint of the port 18, but the central axis 38 may be any other suitable reference line, such as an axis along which the shaft's longitudinal axis 32 is normally positioned either during operation or while the system is at rest, or any other suitable reference line. Thus, determination of the position of the central axis 38 need not necessarily depend on the size, shape (whether regular or irregular) or orientation of the port 18, or depend on any particular orientation of the shaft 12 with respect to the port 18. Instead, the central axis 38 may be any suitable reference line from which the relative position of the shaft 12 may be determined.

Motion of the shaft relative to the port 18 is not limited to angular offset of the shaft 12 as discussed above. In other embodiments, the seal device 10 may allow the shaft 12 to be laterally offset so that the longitudinal axis 32 is parallel to, but spaced from the central axis 38 at a suitable range of distances. The FIG. 2 embodiment may provide for such movement so that the longitudinal axis of the shaft 12 remains perpendicular to the wall 16, but is offset from the central axis 38. Combinations of lateral offset and angular offset of the shaft 12 may also be provided by the seal device 10. Instead of, or in addition to such offset, the seal device 10 may allow reciprocal movement of the shaft 12 into and out of the chamber 14 along the shaft's longitudinal axis 32. Such reciprocal movement may be provided without allowing the shaft 12 to slide longitudinally relative to the shaft seal 22.

In addition to providing movement of the shaft 12 relative to the port 18, the seal device 10 may allow for movement of the shaft 12 relative to sealing portion 44 of the shaft seal 22. For example, the shaft 12 may be free to rotate relative to the sealing portion 44 while sealing engagement is maintained with the shaft. In addition, or alternatively, the shaft 12 may be free to slide along its longitudinal axis 32 relative to the sealing portion 44, e.g., the shaft 12 may be inserted into and/or withdrawn from the chamber 14. This relative movement between the shaft 12 and the sealing portion 44 may allow for greater mobility and usefulness of the shaft 12 as opposed to conditions in which the shaft is not free to move relative to the sealing portion 44 and the range of rotary or sliding movement of the shaft 12 is limited by, for example, the flexibility of the seal mount 24.

In this illustrative embodiment, the seal mount 24 is disposed about substantially the entire outer surface of the shaft seal 22 and is attached to a flange 31 on the seal housing 40 via a retaining ring 70 and an O-ring 72. This arrangement is not required as the seal mount 24 may be attached to the shaft seal 22 in any suitable way, such as having the first end 26 engaged to any portion of the outside surface 30 of the shaft seal 22. The second end 28 of the seal mount 24 is disposed about the port opening 18, and in this illustrative embodiment is attached to a portion of the wall 16 surrounding the port 18 via a retaining ring 72 and O-ring 76. It should be understood that like the first end 26 of the seal mount 24, the second end of the seal mount 24 may be attached to any suitable engagement surface in any suitable way. For example, the seal mount 24 may be attached to the inside surface 35 of the port 18 or a portion of the wall 16 inside the chamber 14. In this embodiment, the retaining rings 70 and 74 are attached to respective engagement surfaces via screws or other fasteners, but other attachment arrangements may be used, such as welding, adhesives, clamps, press fit engagement (e.g., where a retaining ring is press fit into an annular groove in the wall 16), having the retaining rings 70 and 74 threaded and screwed onto their respective engagement surfaces, etc.

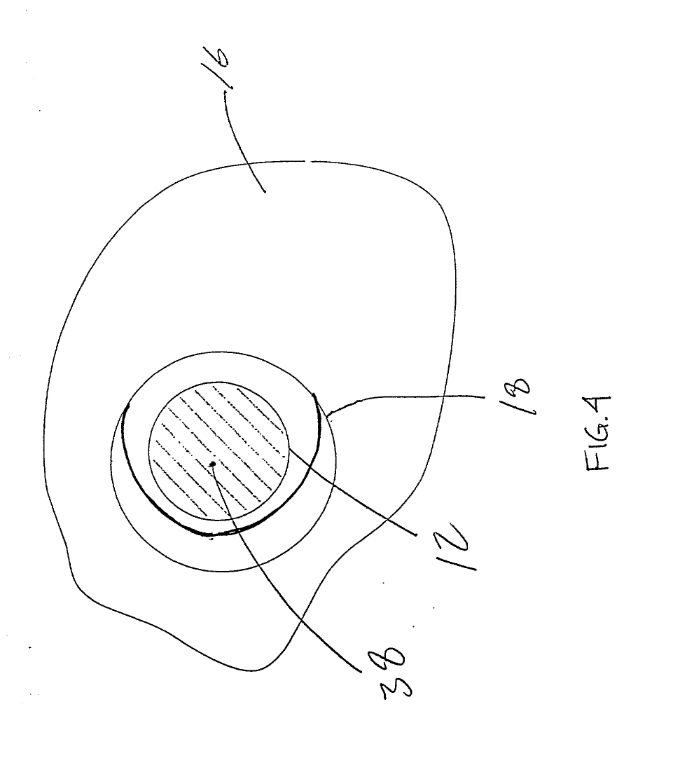

A range of angular motion of the shaft 12 may be limited by the size, shape or other features of the port 18, by the seal device 10 resisting movement beyond a particular range, by separate motion stops and/or other devices. In this embodiment, the port 18 is sized to allow a particular range of angular and lateral offset of the shaft 12 by having a particular size and shape in relation to the portion of the shaft 12 that passes through the port 18. For example, as shown in FIG. 4, the port 18 may be a circular opening that is larger than the portion of the shaft 12 that passes through the port 18, but limits angular offset of the shaft 12 to a cone-shaped area. The invention is not limited to such an arrangement as the port 18 may have any suitable size or shape. Further, the port 18 may include other arrangements, such as a socket joint, that engages with a ball-shaped feature on the shaft 12 and allows angular offset of the shaft 12, but maintains the pivot axis of the shaft in a defined location. Other suitable arrangements for passing the shaft 12 through the wall 16 will occur to those of skill in the art.

In one aspect of the invention, a differential space or chamber 60 may be provided between the bore 42 and the spacer seal 54 or other area near the sealing portion 44. The chamber 60 provides an area where ambient air may have entered the radial gap 46 during the movement of the shaft 12, despite the presence of the sealing portion 44. The chamber 60 allows any such air or other contaminants to be contained and eliminated from the shaft seal 22 via one or more differential lines 62. The differential lines 62 may be in fluid communication with one or more pumps (not shown) that help evacuate the differential chamber 60 and maintain a high vacuum condition in a transition space 34 and possibly in the process chamber 14 itself.

As a result of the mounting arrangement provided by the flexible seal mount 24 and shaft seal 22, some embodiments of the present invention may provide for a continuous vacuum seal about a shaft 12 that may be inserted, withdrawn and/or manipulated within a process chamber 14 through a wide range of motion and/or positions. By providing a vacuum seal which may be maintained about the shaft 12 even when the shaft is offset relative to the central axis of the port, an ion implanter, or other device which requires the use of vacuum seals about moving shafts, is provided with the ability to insert and manipulate shafts and their associated tools, such as Faraday cups, actuating arms, etc., in a vacuum chamber with lower cost and greater ease of use.

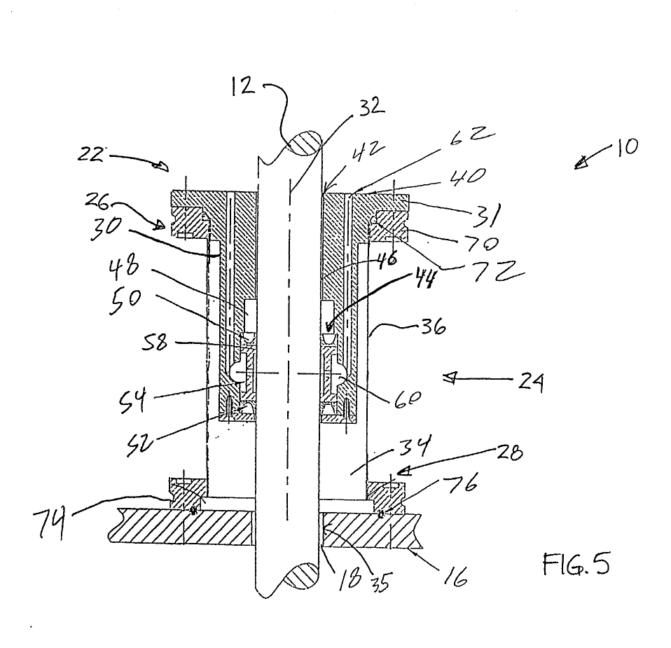

FIG. 5 shows another illustrative embodiment in accordance with the invention. This embodiment is similar to that shown in FIG. 2, so only differences between embodiments are discussed below. In the FIG. 5 embodiment, the flexible member 36 is not formed as a bellows, but instead has walls substantially free of undulations or other bellows features. The flexible member 36 may be made of any suitable material as discussed above, or combination of materials, such as a metallic wire-reinforced rubber tube. In this embodiment, the port 18 size, in at least the dimension shown, is close to that of the shaft portion that passes through the port 18. As a result, angular and lateral offset of the shaft 12 may be limited in the plane of the drawing of FIG. 5. (Offset of the shaft 12 may be less restricted in a plane transverse to that of FIG. 5, since the port 18 may be an elongated slot that extends in a direction perpendicular to plane of FIG. 5.) Therefore, the seal mount 24 may resist angular and lateral offset of the shaft 12, but allow reciprocal movement of the shaft 12 along its longitudinal axis 32. Further, the seal mount 24 may resist offset in some directions, but freely allow shaft offset in other directions. For example, the flexible member 36 may be compliant to bending in one plane, but resist bending in another transverse plane.

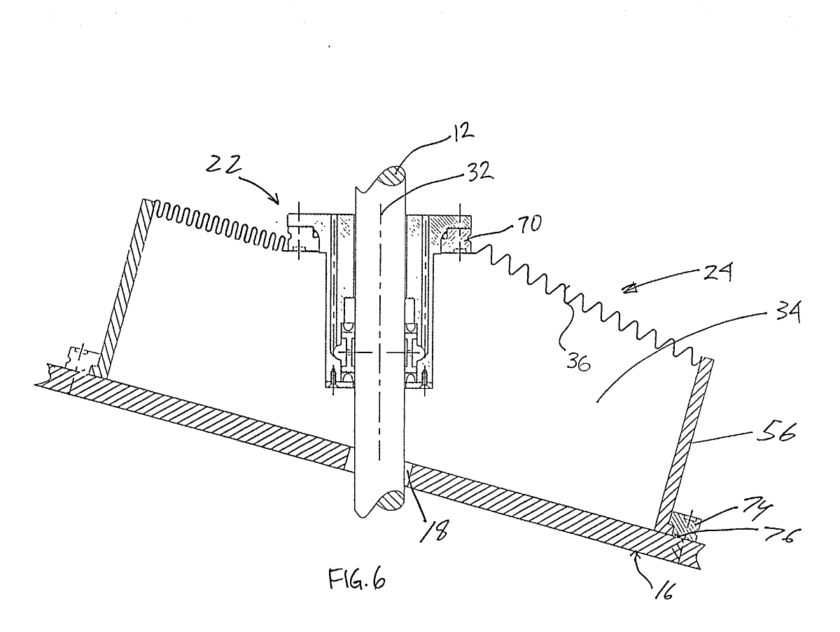

FIG. 6 shows yet another illustrative embodiment in accordance with the invention. In this embodiment, the seal mount 24 includes a cylindrical wall member 56 that is attached to the chamber wall 16 by a retaining ring 74 and extends upward away from the wall 16. The cylindrical wall member 56 in this embodiment is a rigid member, such as a cylindrical steel tube, but may have any suitable size, shape or other features. A flexible member 36 is attached at a top end of the wall member 56 and extends substantially parallel to the wall 16 to the shaft seal 22. In this embodiment, the flexible member 36 may have a substantially washer-like shape, i.e., a substantially circular shape with an opening in the center for the shaft seal 22. As a result, the shaft seal 22 may be moved, along with the shaft 12, so the shaft 12 is offset relative to the port 18 in any suitable way. As in the embodiments above, the flexible member 36 accommodates the shaft seal movement, while substantial sealing engagement is maintained between the shaft seal 22 and the shaft 12. Of course, the seal mount 24 need not include the wall member 56, and instead may include only the flexible member 36. Further, the flexible member 36 need not have the specific bellows configuration shown in FIG. 6, and may be a substantially flat member, concave, convex, a cone shape, or any other suitable configuration. The wall member 56 and flexible member 36 need not be circular or cylindrical, but may have any suitable shape, such as rectangular, oval, etc.

In addition to being directed to the embodiments described above and claimed below, the present invention is further directed to embodiments having different combinations of the features described above and claimed below. As such, the invention is also directed to other embodiments having any other possible combination of the dependent features claimed below.

The above examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

1. A sealing device for providing a seal about a shaft that extends between first and second zones where a pressure differential exists between the first and second zones, the sealing device comprising:
a shaft seal having a sealing portion and a support portion, the sealing portion constructed and arranged to sealingly engage with a shaft and allow the shaft to be at least one of slidingly and rotationally moved relative to the sealing portion; and
a seal mount having a first end, a second end and a flexible member between the first and second ends that enables movement of the first end relative to the second end in at least one degree of freedom, the first end being sealingly engageable to at least a portion of the support portion of the shaft seal, the second end being sealingly engageable to an engagement surface about a port into a process chamber.

2. The sealing device of claim 1, wherein the flexible member defines a transition space in the first zone, the transition space being in fluid communication with the process chamber.

3. The sealing device of claim 1, wherein the port comprises a central axis, the flexible member allowing movement of the shaft seal in at least two degrees of freedom relative to the central axis of the port.

4. The sealing device of claim 1, wherein the port further comprises a port size and a portion of the shaft extending through the port has a shaft size, the port size being substantially larger than the shaft size.

5. The sealing device of claim 1, wherein the port comprises a central axis, and the shaft seal is movable to allow the shaft to be angularly offset relative to the central axis of the port.

6. The sealing device of claim 1, wherein the port comprises a central axis, and the shaft seal is movable to allow the shaft to be laterally offset relative to the central axis of the port.

7. The sealing device of claim 1, wherein the sealing portion of the shaft seal sealingly engages with a cylindrically-shaped portion of the shaft.

8. The sealing device of claim 1, wherein the sealing portion sealingly engages the shaft so that the shaft may be both slidingly and rotationally moved relative to the sealing portion.

9. The sealing device of claim 1, wherein the sealing portion sealingly engages the shaft so that the shaft may be rotationally moved, but not slidingly moved, relative to the sealing portion.

10. The sealing device of claim 1, wherein the support portion includes a housing having a shaft bore with an inner surface, the shaft bore constructed and arranged to allow the shaft to pass through the shaft bore.

11. The sealing device of claim 1, wherein the support portion of the shaft seal is characterized as being substantially rigid.

12. The sealing device of claim 11, wherein the shaft seal includes a portion constructed from at least one member of the group consisting of metals, powder metals, ceramics, metallo-ceramics, rigid plastics, and combinations thereof.

13. The sealing device of claim 1, wherein the flexible member includes at least one of natural rubber, silicone rubber, and elastomeric polymer materials.

14. The sealing device of claim 1, wherein the flexible member includes a plurality of undulations.

15. The sealing device of claim 1, wherein the flexible member includes a bellows portion.

16. The sealing device of claim 1, further comprising a first retaining ring constructed and arranged to sealingly engage a first end of the flexible member to the shaft seal.

17. The sealing device of claim 16, further comprising a first O-ring positioned between the first retaining ring and the shaft seal.

18. The sealing device of claim 1, further comprising a second retaining ring constructed and arranged to sealingly engage a second end of the flexible member to an engagement surface of the process chamber.

19. The sealing device of claim 18, further comprising a second O-ring positioned between the second retaining ring and the engagement surface.

20. The sealing device of claim 1, wherein the flexible member includes a flexible collar.

21. The sealing device of claim 20, wherein the shaft is moveable in a reciprocating manner relative to the shaft seal and the port.

22. The sealing device of claim 20, wherein the shaft is moveable in a rotating manner relative to the shaft seal and the port.

23. The sealing device of claim 1, wherein the sealing member comprises:
a first seal member, a second seal member, and a spacer seal member positioned therebetween, each of the seal members having a first surface and a second surface, the first surface being supported by the support portion and the second surface being sealingly associated with the shaft.

24. The sealing device of claim 23, further comprising a differential space between the first and second seal members, the differential space being fluidly connectable with a vacuum source.

25. The sealing device of claim 24, wherein the differential space is located between the spacer seal member and the support portion.

26. The sealing device of claim 25, wherein the seal mount defines a transition space in the first zone, and the differential space is fluidly connectable to the transition space.

27. A floating shaft seal for providing a vacuum seal about a reciprocating and/or rotating shaft, wherein the shaft is passed from a zone at ambient air pressure through an opening in a chamber, the chamber having a substantially lower pressure than ambient, the floating shaft seal comprising:
a sealing member constructed and arranged to sealingly engage with a shaft and allow the shaft to move relative to at least a portion of the sealing member; and
a flexible mounting collar having a first end opening and a second end opening, the first end opening being sealingly engageable with the sealing member, the second end opening sealingly engageable about the opening in the chamber.

28. The shaft seal of claim 27, wherein the opening in the chamber has a central axis, and the sealing member and flexible mounting collar are constructed and arranged to allow the shaft to be offset relative to the central axis.

29. The shaft seal of claim 28, wherein the sealing member and the flexible mounting collar are constructed and arranged to allow the shaft to be rotated about an axis transverse to the central axis.

30. The shaft seal of claim 27, wherein the sealing member is constructed and arranged to allow the shaft to rotate relative to at least a portion of the sealing member.

31. The shaft seal of claim 27, wherein the sealing member is constructed and arranged to allow the shaft to slide along a longitudinal axis of the shaft relative to at least a portion of the sealing member.

32. The shaft seal of claim 27, wherein a portion of the sealing member sealingly engages with a cylindrical portion of the shaft.

33. A device for maintaining a seal about a mobile shaft that extends from a first chamber into a second chamber, the first chamber having a first pressure, the second chamber having a second pressure, the device comprising:
an inner housing having an inside surface and an outside surface, the inside surface defining a substantially cylindrical passage, a first portion of the substantially cylindrical passage having a first diameter sized to allow passage of the shaft therethrough;
an upper mechanical seal member, a lower mechanical seal member, and a spacer seal member positioned therebetween, each of the seal members having a first surface and a second surface, the first surface being supported by the first portion of the substantially cylindrical passage, the second surface being sealingly engaged with the shaft; and
an outer housing comprising a flexible member and having a first end and a second end, the first end sealingly engaged to a portion of the outside surface of the inner housing, the second end sealingly engaged to a wall of the second chamber, the outer housing flexibly supporting the inner housing so the inner housing is moveable relative to the wall of the second chamber.

34. The device of claim 33, further comprising:
a differential space between the first surface of the spacer seal member and the first portion of the substantially cylindrical passage; and
a differential pumping line in fluid communication with the differential space, the differential pumping line extending from the differential space through the inner housing.

35. An ion beam measuring device comprising:
a vacuum chamber having an inside and an outside, the vacuum chamber being defined by a plurality of walls and housing an ion beam projected from a beam source, one of the plurality of walls having an opening;
a shaft having a first end and a second end, the shaft passing through the opening in one of the plurality of walls in the vacuum chamber;
a measuring device operatively engaged to the first end of the shaft;
a control unit positioned on the outside of the vacuum chamber and engaged with the second end of the shaft; and
a seal device mounted adjacently to a wall of the vacuum chamber, the seal device having a flexible member and sealingly engaging the shaft so the shaft is free to at least one of rotate and slide relative to the seal device, the seal device being sealingly engaged about the opening in one of the plurality of walls and resisting fluid flow from outside the vacuum chamber through the opening in one of the plurality of walls, the flexible member allowing the shaft to be offset relative to the opening in one of the plurality of walls while sealing engagement is substantially maintained with the shaft.
